(19) United States
(12) Patent Application Publication
(10) Pub. No.: US 2022/0373043 A1
(43) Pub. Date: Nov. 24, 2022

(54) METHOD AND SYSTEM FOR ESTIMATING CLUTCH PARAMETERS

(71) Applicants: Hussein DOURRA, Bloomfield, MI (US); Guoming ZHU, Novi, MI (US); Wenpeng WEI, East Lansing, MI (US)

(72) Inventors: Hussein DOURRA, Bloomfield, MI (US); Guoming ZHU, Novi, MI (US); Wenpeng WEI, East Lansing, MI (US)

(21) Appl. No.: 17/640,492

(22) PCT Filed: Sep. 1, 2020
(86) PCT No.: PCT/US2020/048944

§ 371 Date: Mar. 4, 2022

Related U.S. Application Data
(60) Provisional application No. 62/896,740, filed on Sep. 6, 2019.
(60) Provisional application No. 63/050,250, filed on Jul. 10, 2020.

(51) Int. Cl. F16D 48/08; F16D 23/12

(52) U.S. Cl. CPC F16D 48/08; F16D 23/12; F16D 2500/30402; F16D 2500/30404; F16D 2500/30415; F16D 2500/30426; F16D 2500/1045; F16D 2500/50236; F16D 2500/50245; F16D 2500/7082; F16D 2500/30421; F16D 2023/123

(57) ABSTRACT

A method of controlling a component of a powertrain of a vehicle is provided. The method comprises calculating an estimated clutch surface friction coefficient as a function of an initial clutch surface friction coefficient, a temperature of the clutch, and a rotational speed difference between a driving part and a driven part of the clutch; and adjusting a command signal to the component of the powertrain based upon the estimated clutch surface friction coefficient. A method of controlling a component of a powertrain of a vehicle comprises: estimating a clutch touchpoint x_{ct} of a clutch controlled by a clutch actuation system including a ballramp system, based on the variables of the system to determine the translation of the ball for which the clutch will transmit torque; and adjusting a command signal to the component of the powertrain based upon the estimated clutch touchpoint x_{ct} of the clutch.

### CROSS-REFERENCE TO RELATED APPLICATIONS

This PCT International Patent application claims the benefit of and priority to U.S. Provisional Patent Application Ser. No. 62/896,740 filed on Sep. 6, 2019, titled “Clutch Kiss Point Detection System,” and U.S. Provisional Patent Application Ser. No. 63/050,250 filed on Jul. 10, 2020, titled “Method And System For Estimating Clutch Surface Friction Coefficient,” the entire disclosures of which is hereby incorporated by reference.

### TECHNICAL FIELD

The present disclosure relates to vehicle transmission systems. More particularly, the present disclosure relates to a transfer case and a clutch actuation system thereof.

### BACKGROUND OF THE DISCLOSURE

Vehicle drivetrains, in particular vehicle drivetrains for a four-wheel drive capable vehicle, typically include a powertrain operable to generate rotary power, such as drive torque, which is transmitted via a transfer case to a primary driveline and a secondary driveline. The powertrain may include a prime mover, such as an engine or an electric traction motor, and a transmission. The prime mover is configured to rotate an input shaft, which is selectively operable via the transfer case to convert the rotary motion of the input shaft into rotary motion of the vehicle axles.

The transfer case typically includes the input shaft, and further includes a rear output shaft and a front output shaft, for driving the rear axle and the front axle, which may be part of a primary and secondary driveline. The transfer case may include a clutch pack for a friction clutch mechanism, with a rotary to linear conversion mechanism, such as a ballramp unit, ballscrew unit, camming devices, pivotable devices, or the like, configured to control the magnitude of a clutch engagement force applied to the clutch pack. The clutch pack is operable to control the transfer of torque between shafts that are selectively coupled via the clutch pack.

The clutch engagement force may have a minimum engagement force in which a minimal amount of drive torque is transferred between the shafts. The clutch assembly may also have a released mode for the friction clutch in which no drive torque is transferred. The clutch assembly may further include a maximum clutch engagement force.

To control the transfer of torque between shafts, it is desirable to know the minimum and maximum clutch engagement forces, which may be dependent on the rotary to linear conversion mechanism.

One value in controlling the engagement of the clutch assembly to transmit torque is the clutch “kiss point.” The kiss point is the value of the control variable in a clutch system where the friction clutch will begin to transmit torque. The kiss point may also be considered to be related to the minimum engagement force. However, it can be difficult to accurately determine the kiss point of a clutch system without substantial experimentation, which can be costly, due to the high number of variables associated with the components of a clutch system.

Physical characteristics of a clutch in a vehicle powertrain are important parameters for modeling and understanding vehicle performance and operation. One such physical characteristic is the surface friction coefficient, which affects the amount of torque transmitted through the clutch. Improved estimates of the clutch surface friction coefficient can lead to improvements in vehicle powertrain control.

Accordingly, improvements can be made in the determination of the clutch kiss point and the surface friction coefficient.

### SUMMARY

In accordance with an aspect of the disclosure, a method of controlling a component of a powertrain of a vehicle comprises: calculating an estimated clutch surface friction coefficient as a function of an initial clutch surface friction coefficient, a temperature of the clutch, and a rotational speed difference between a driving part and a driven part of the clutch; and adjusting a command signal to the component of the powertrain based upon the estimated clutch surface friction coefficient. The component of the powertrain is one of a clutch actuator configured to actuate the clutch or a prime mover configured to supply an input torque to the driving part of the clutch.

In accordance with an aspect of the disclosure, a method of controlling a component of a powertrain of a vehicle is provided. The method comprises: estimating a clutch touchpoint x_{ct} of a clutch controlled by a clutch actuation system including an electric motor having a first shaft, a reduction gear coupled to the first shaft, a second shaft coupled to the reduction gear, and a cam system coupled to the first shaft; and adjusting a command signal to the component of the powertrain based upon the estimated clutch touchpoint x_{ct} of the clutch, where the component of the powertrain is one of the clutch actuation system or a prime mover configured to supply an input torque to a driving part of the clutch. The cam system includes a ball configured to translate in an axial direction and to impart a clutch engagement force on a clutch pack, wherein rotation of the second shaft causes an axial translation of the ball; and the clutch touchpoint x_{ct} corresponds to the axial translation of the ball where the clutch pack first transmits torque. The step of estimating the clutch touchpoint x_{ct} of the clutch includes determining the clutch touchpoint x_{ct} as a function of: a conversion rate correlating the axial translation of the ball to a rotation angle of a plate defining a ramp and configured to rotate about an axis to cause the axial translation of the ball, a total friction force on the ball, an angle between the ramp and a plane of the plate perpendicular to the axis, an axial stiffness of a clutch spring acting upon the clutch, a reduction gear ratio of the reduction gear, an equivalent gear ratio between the second shaft and the plate, a mechanical efficiency between the first shaft and the second shaft, a mechanical efficiency between the second shaft and the plate, a mechanical efficiency between the plate and the ball, and an orbital radius of the ball.

### A BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a schematic view of a clutch actuation system;

FIG. 2 illustrates estimation results of a first case of a touchpoint estimation system;

FIG. 3 illustrates estimation results of a second case of a touchpoint estimation system;

FIG. 4 illustrates touchpoint estimation results using an adaptive normalized gradient approach with a linear spring case and with a nonlinear spring case;

FIG. 5 illustrates touchpoint estimation results using an adaptive normalized least-squares estimation algorithm;

FIG. 6 illustrates a schematic block diagram of a system for modeling surface friction coefficient of a clutch in accordance with the present disclosure;

FIG. 7 illustrates an end view of a clutch disk in accordance with the present disclosure;

FIG. 8 illustrates a free body diagram of a vehicle;

FIG. 9 illustrates a side view diagram of a tire;

FIG. 10 illustrates a free body diagram of a tire;

FIG. 11 illustrates a graph with plots of acceleration, tire radius, vehicle speed, and clutch torque over a common time scale;

FIG. 12 illustrates shows a graph with plots of vehicle speed and clutch torque over a common time scale;

FIG. 13 is a flow chart illustrating steps in a first method of controlling a component of a powertrain; and

FIG. 14 is a flow chart illustrating steps in a first method of controlling a component of a powertrain.

### DESCRIPTION OF THE ENABLING EMBODIMENT

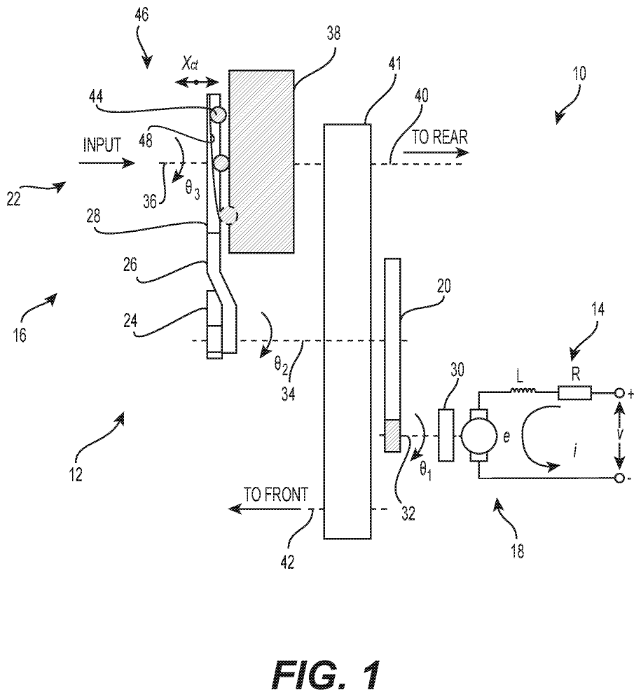

Referring initially to FIG. 1, a transfer case 10 is illustrated schematically, and includes a clutch actuation system 12. The clutch actuation system 12 illustrated schematically is based on a transfer-case type clutch actuation system. It will be appreciated that the clutch actuation system 12 may be one part of the overall transfer case system, which is not shown in detail.

The clutch actuation system 12 is an electromechanical system, and includes an electrical portion 14 and a mechanical portion 16. The electrical portion 14 and the mechanical portion 16 operate together to control the clutch actuation system 12.

The electrical portion 14 includes an electric motor 18, and the mechanical portion 16 includes a reduction gear 20 and a cam system 22. The cam system 22 may include a cam 24, a lever 26, and a plate 28. The electric motor 18 includes a rotor 30 that is rotated in response to an electric current applied to the motor 18. The rotor 30 is coupled to the reduction gear 20 via a first shaft 32, such that actuation of the motor 18 and rotation of the rotor 30 causes rotation of the reduction gear 20. The reduction gear 20 is further coupled to the cam 24 of the cam system 22 via a second shaft 34. Thus, rotation of the reduction gear 20 will cause rotation of the second shaft 34 and the cam 24 coupled thereto.

The transfer case 10 further includes a plurality of rotatable shafts that are part of the powertrain and drivetrain system of the vehicle. As shown schematically in FIG. 1, an input shaft or third shaft 36 is coupled to one side of a clutch pack 38, which may also be called a clutch 38. A rear shaft 40 is coupled to the opposite side of the clutch pack 38. A chain 41 couples the rear shaft 40 to a front shaft 42.

The cam system 22 may further include one or more balls 44 that are part of a ballramp system 46. Actuation of the cam system 22 will cause the balls 44 to travel as part of the ballramp system 46, thereby causing linear/axial movement of the cam system 22, which will impart a clutch engagement force on the clutch pack 38. With the clutch pack 38 engaged and transmitting torque, rotation of the third shaft 36 will cause rotation of the rear shaft 40 and the front shaft 42. More specifically, the plate 28 defines a ramp 48 that interacts with the one or more balls 44 to cause the one or more balls 44 to translate, or to move, in an axial direction parallel to an axis of rotation of the plate 28, as the plate 28 is rotated. The one or more balls 44 are disposed between the ramp 48 of the plate 28 and the clutch pack 38, so this translation of the one or more balls 44 applies pressure to the clutch pack 38 which results in the clutch engagement force. Torque is selectively transmitted by the clutch pack 38 between the third shaft 36 and the rear shaft 40 when the clutch pack 38 is subjected to the clutch engagement force. It will be appreciated that other arrangements of the shafts may also be used, and that the clutch pack 38 may be coupled to different types of shafts for selectively transferring torque between shafts.

To operate the clutch actuation system 12, the motor 18 may be actuated by an electric current (i) to the motor 18, which will cause rotation or angular displacement of the first shaft 32. Rotation or angular displacement of the first shaft 32 will cause rotation and angular displacement of the second shaft 34, according to the ratio of the reduction gear 20. Rotation or angular displacement of the second shaft 34 will cause movement of the cam system 22 and, ultimately, engagement of the clutch pack 38.

The kiss point or touchpoint of the clutch actuation system 12 can be estimated as follows.

### 1. Adaptive Normalized Gradient Approach

Two cases are considered for the adaptive normalized gradient approach: linear spring case and nonlinear spring case.

Case 1: Estimation Algorithm based on Linear Clutch Spring

The equation that describes the electrical portion 16 can be represented by the following:

$$v = Ri + L \frac{di}{dt} + {K}_{e} {\dot{θ}}_{1} \qquad ( 1 )$$

where i is the applied current in the motor 18; θ₁ is the angular position of the first shaft 32; v is the voltage supplied to the electric motor 18; parameters R, L and Kₑ represent the resistance, the inductance and the electromotive force constant, respectively.

The mechanical aspects of the motor 18 can be modelled by the following equation:

=Jₘ\ddot{θ}₁=Kₘi−b₁\dot{θ}₁−Tₗ₁ (2)

where Jₘ is the electric motor inertia; Kₘ is the motor torque constant; b₁ is the damping of first shaft 32; and Tₗ₁ is the torque load from the first shaft 32.

The reduction gear can be simply represented by the following equation if the gear lash is ignored:

\dot{θ}₂=\dot{θ}₁/iᵣ (3)

where iris the reduction gear ratio; \dot{θ}₁ is the angular velocity of the first shaft 32; and \dot{θ}₂ is the angular velocity of second shaft 34.

The cam shaft-lever-ball subsystem of the cam system 22 converts the rotation angle of the second shaft 34 to the ball 44 displacement Xb. The conversion relationship between the cam angle to the following stroke is typically nonlinear, but in the 4-wheel-drive normal working range, the relationship is quite linear. Thus, the relationship between them can be expressed by:

s=k_{cam}θ₂+a_{cam} (4)

where s is the stroke of the cam 24, θ₂ is the angular position of second shaft 34, and k_{cam} and a_{cam} are constants. The cam 24 rotates the plate 28 on the third shaft 36 through the lever arm 26 and the rotation angle θ₃ of the plate 28 can be modelled as:

θ₃=kₚs+aₚ (5)

where kₚ and aₚ are constants.

The ball ramp relationship, which is the relationship between the displacement of the ball 44 displacement and the rotation angle θ₃ of the plate 28, is also a linear function, and can be modeled as following:

x_{b}=p₀θ₃ (6)

where p₀ is the conversion rate and x_{b} is the total displacement of the ball 44.

Combining all equations above, the total displacement of the ball 44 can be expressed as:

$${x}_{b} = {p}_{0} \frac{{k}_{p} {k}_{c a m} {θ}_{1}}{{i}_{r}} + {p}_{0} {k}_{p} {a}_{c a m} + {p}_{0} {a}_{p} \qquad ( 7 )$$

Although the clutch touchpoint is initially designed as a constant x_{c0}, the total touchpoint varies over time. Consider the touchpoint variation as x₀, the total touchpoint displacement x_{ct} now becomes:

x_{ct}=x_{c0}x₀ (8)

The relationship between the clutch displacement and the clutch force can be expressed as:

$${F}_{N} = \{ \begin{matrix}0 & {x}_{b} \leq {x}_{c t} \\ {k}_{c} ( {x}_{b} - {x}_{c t} ) & {x}_{b} > {x}_{c t}\end{matrix} \qquad ( 9 )$$

where F_{N} is the clutch normal force; and is an axial stiffness of a clutch spring within the clutch 38.

The load torque comes from the contact of the ball 44 and the clutch surface. The force that drives the ball 44 to rotate along the ramp 48 of the plate 28 is the force that will introduce the load torque to the third shaft 36, and it can be represented by:

3F_{b}=F_{N} tan β (10)

where F_{b} is the tangential force on the ball 44 in a plate plane extending perpendicular to the axis about which the plate 28 rotates; and β is the angle between the ramp 48 and the plate plane of the plate 28.

In one aspect, there are three balls 44 and three ramps 48 distributed at regular intervals on the plate 28 (i.e. the ramps 48 are each spaced apart by 120 degrees). Thus, the load torque on the third shaft 36 can be obtained by:

Tₗ₃ηₚ=(3F_{b}F_{f})r_{b} (11)

where r_{b} is the radius of the ball's orbit; Tₗ₃ is the load torque exerted on the third shaft 36, ηₚ is the mechanical efficiency from the plate to the ball, and F_{f} is the total friction force on the ball 44. The total friction force F_{f} is modeled as the general friction:

$${F}_{f} = \{ \begin{matrix}( {F}_{c} + ( {F}_{s} - {F}_{c} ) {e}^{- \vert \frac{v}{{v}_{s}} \vert \vert} ) sign ( v ) + {F}_{v} v & \vert v \vert > {v}_{0} \\ - {F}_{e} & \vert v \vert \leq {v}_{0} \&\& {F}_{e} < {F}_{s} \\ sign ( v ) {F}_{s} & \vert v \vert \leq {v}_{0} \& \& {F}_{e} \geq {F}_{s}\end{matrix} \qquad ( 12 )$$

where F_{C} is the Coulomb friction; Fₛ is the Stiction friction; Fₑ is External force; Fᵥ is the viscous friction coefficient; v is the movement velocity of the ball 44; vₛ is the Stribeck velocity; and v₀ is threshold velocity.

Combining all the equations, the load torque on the third shaft 36 will be

Tₗ₃ηₚ=(F_{N} tan β+F_{f})r_{b} (13)

Note that the torque relationship between the first shaft to the second shaft and between the second shaft to the third shaft can be represented below, respectively.

Tₗ₂=Tₗ₁iᵣηᵣ (14)

Tₗ₃=Tₗ₂iₛηₛ (15)

where ηᵣ is the mechanical efficiency coefficient from the first shaft 32 to the second shaft 34, iₛ is the equivalent gear ratio between the second shaft 34 and the plate 28 resulting from the action of the cam system 22 to rotate the plate 28; and ηₛ is the mechanical efficiency coefficient between the second shaft 34 and the plate 28 resulting from the action of the cam system 22 to rotate the plate 28.

Considering the torque ratio in the mechanical connection from the third shaft 36 to the first shaft 32, when the clutch 38 is engaged, the load torque on the first shaft 32 is:

$${T}_{l 1} = K {θ}_{1} + d \qquad ( 16 )$$

$$where K = \frac{{k}_{c} tan β {r}_{b} {k}_{c a m} {p}_{0} {k}_{p}}{{i}_{r}^{2} {i}_{s} {η}_{r} {η}_{s} {η}_{p}} and d = \frac{{k}_{c} tan β {r}_{b}}{{i}_{r} {i}_{s} {η}_{r} {η}_{s} {η}_{p}} ( {p}_{0} {k}_{p} {b}_{c a m} + {p}_{0} {a}_{p} - {x}_{c t} + \frac{{F}_{f}}{tan β {k}_{c}} ) .$$

This completes the clutch actuation system 12 modeling.

With the clutch actuation system 12 being modeled, a model-based adaptive estimation algorithm has been established for estimating the clutch touchpoint.

For the preparation of developing the adaptive estimation algorithm, choose the states as

$$x = {[ {x}_{1} , {x}_{2} , {x}_{3} ]}^{T} = {[ {θ}_{1} , {\dot{θ}}_{1} , \frac{{K}_{e}}{{J}_{m}} i ]}^{T} ,$$

the state space representation of the system becomes:

$${\dot{x}}_{1} = {x}_{2} {\dot{x}}_{2} = {x}_{3} - \frac{b}{{J}_{m}} {x}_{2} - \frac{K}{{J}_{m}} {x}_{1} - \frac{d}{{J}_{m}} {\dot{x}}_{3} = - \frac{{K}_{e} {K}_{l}}{{J}_{m} L} {x}_{2} - \frac{R}{L} {x}_{3} + \frac{{K}_{e}}{{J}_{m} L} v y = {x}_{1} \qquad ( 17 )$$

A more compact form of the system can be read as:

$$\dot{x} = Ax + {B}_{u} u + {B}_{d} d y = Cx \qquad ( 18 )$$

$$where A = [ \begin{matrix}0 & 1 & 0 \\ - \frac{K}{{J}_{m}} & - \frac{b}{{J}_{m}} & 1 \\ 0 & - \frac{{K}_{e} {K}_{t}}{{J}_{m} L} & - \frac{R}{L}\end{matrix} ] , {B}_{u} = [ \begin{matrix}0 \\ 0 \\ \frac{{K}_{e}}{{J}_{m} L}\end{matrix} ] , {B}_{d} = [ \begin{matrix}0 \\ \frac{- 1}{{J}_{m}} \\ 0\end{matrix} ] , C = [ \begin{matrix}1 & 0 & 0\end{matrix} ]$$

and the term d is the unknown input due to the touchpoint.

In this case, the transfer function representation of the system is in the form of:

y(s)=Gᵤ(s)u(s)+G_{d}(s)d(s) (19)

where Gᵤ(s)=C(sI−A)⁻¹Bᵤ,G_{d}(s)=C(sI−A)⁻¹B_{d}.

In preparation for the adaptive estimation of the unknown term d, using the hybrid notation containing both time domain and frequency domain signal, rearrange the above equation.

y(t)−Gᵤ(s)u(t)=G_{d}(s)d (20)

Rewrite it as:

y′(t)=θφ(t) (21)

where γ′(t)=y(t)−Gᵤ(s)u(t),d=θ and φ(t)=G_{d}(s)*1. This is the linear parametric model for the adaptive estimation. If we choose the normalized gradient method, the adaptive law can be designed as:

$$\dot{θ} = - \frac{γ}{{m}^{2} ( t )} ε ( t ) φ ( t ) \\ {m}^{2} ( t ) = 1 + {k φ}^{T} ( t ) φ ( t ) \\ ε ( t ) = d φ ( t ) - {y}^{′} ( t ) \qquad ( 22 )$$

where γ and k are designing adaptive parameters.

Once the unknown term dis estimated and converged, the clutch touchpoint x_{ct} can be obtained from equation (16):

$${x}_{c t} = {p}_{0} {k}_{p} {b}_{c a m} + {p}_{0} {a}_{p} + \frac{{F}_{f}}{{tan β k}_{c}} - \frac{{i}_{r} {i}_{s} {η}_{r} {η}_{s} {η}_{p}}{{k}_{c} {tan β r}_{b}} d \qquad ( 23 )$$

Accordingly, in view of the above, the clutch touchpoint x_{ct} can be estimated and determined based on the modeling of the clutch actuation system 12 and the above-described adaptive estimation process.

Case 2: Estimation Algorithm based on Nonlinear Clutch Spring

In equation (9), the clutch spring stiffness is assumed to be linear. However, in practical, the spring stiffness may be nonlinear, especially when the clutch works under overtaken condition. Therefore, in this case, the estimation algorithm based on nonlinear spring stiffness is developed. Consider the nonlinear spring stiffness takes the following form.

$${F}_{N} = \{ \begin{matrix}0 & {x}_{b} \leq {x}_{ct} \\ {k}_{c 1} ( {x}_{b} - {x}_{ct} ) + {{k}_{c 2} ( {x}_{b} - {x}_{ct} )}^{3} & {x}_{b} > {x}_{ct}\end{matrix} \qquad ( 24 )$$

where k_{c1} is the linear portion coefficient of the spring stiffness; and k_{c2} is the nonlinear portion coefficient of the spring stiffness.

Comparing with the linear spring case, the change is mainly in the load torque on shaft 3 (i.e. the third shaft 36) described by equation (13). Therefore, the load torque on the first shaft 32 will be changed accordingly. With certain manipulation, the load torque on the first shaft 32 can be expressed as:

$${T}_{l 1} = {K}^{′} {θ}_{1} + {d}^{′} \qquad ( 25 )$$

$$where {K}^{′} = \frac{{k}_{c} tan {β r}_{b} {k}_{cam} {p}_{o} {k}_{p}}{{i}_{r}^{2} {i}_{s} {η}_{r} {η}_{s} {η}_{p}} and$$

$${d}^{′} = \frac{{k}_{c} tan {β r}_{b}}{{i}_{r}^{2} {i}_{s} {η}_{r} {η}_{s} {η}_{p}} ( {p}_{0} {k}_{p} {b}_{cam} + {p}_{0} {a}_{p} - {x}_{ct} + \frac{{F}_{f}}{tan {β k}_{c}} + \frac{{k}_{c 2}}{{k}_{c 1}} {( {x}_{b} - {x}_{ct} )}^{3} ) .$$

Note that K′ is the same as K in the linear case and term d′ now contains the nonlinear cubic unknown term. The adaptive estimation algorithm as the linear spring case can still be used, however, the estimated unknown term now becomes d′, instead of d. The third order nonlinear equation needs to be solved to obtain the touchpoint x_{ct}.

### 2. Adaptive Normalized Least-Squares Estimation Algorithm

In the adaptive normalized Least-Squares estimation algorithm, only the linear spring case is considered. The algorithm is developed based on the equations (16) and (21). Specifically, the Least-Squares estimation algorithm is design as the following form.

$$θ ( k + 1 ) = θ ( k ) - \frac{P ( k ) ϕ ( k ) ε ( k )}{κ + {( ϕ ( k ) )}^{T} P ( k ) ϕ ( k )} P ( k + 1 ) = P ( k ) - \frac{P ( k ) ϕ ( k ) {( ϕ ( k ) )}^{T} P ( k )}{κ + {( ϕ ( k ) )}^{T} P ( k ) ϕ ( k )} \qquad ( 26 )$$

where κ is the design parameter, P(k) is the ‘gain’ matrix.

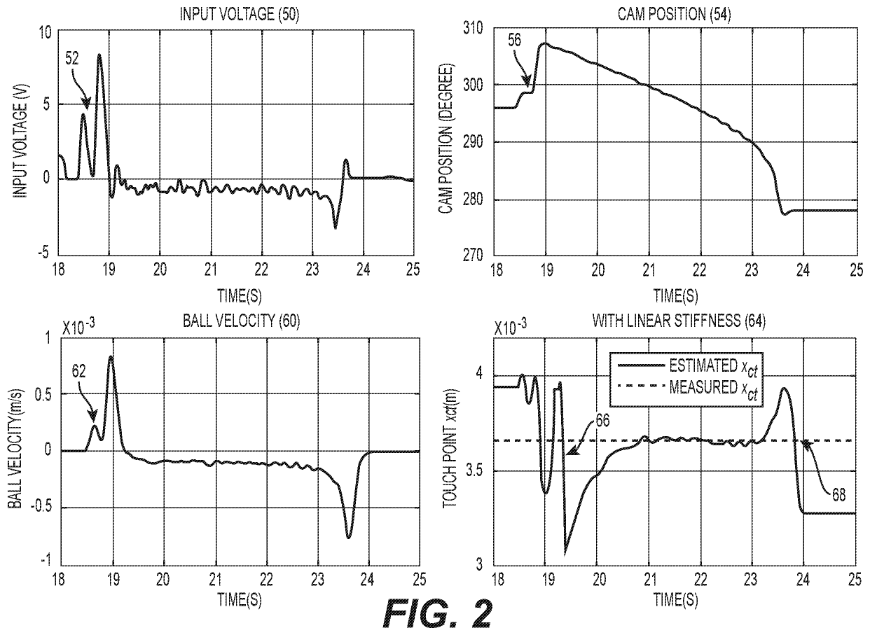

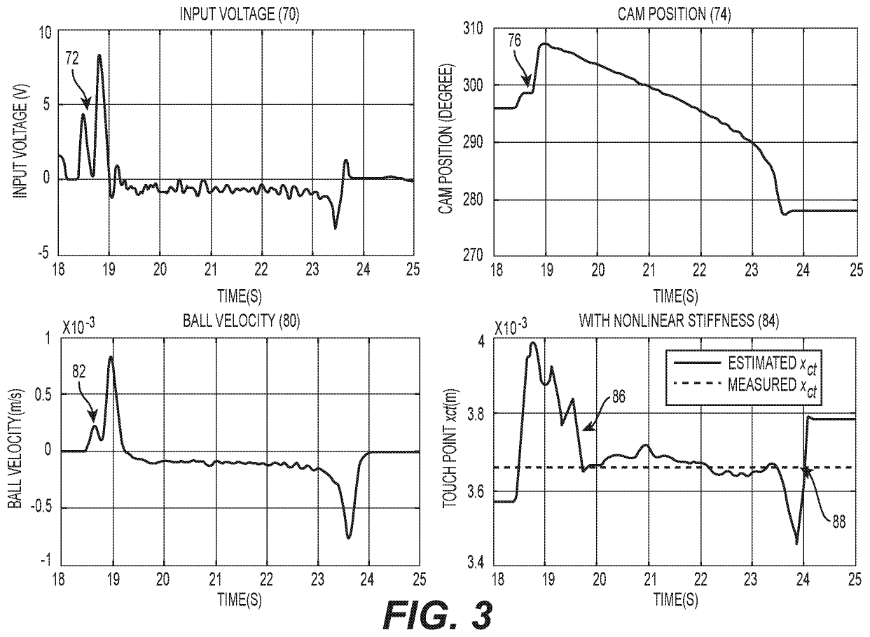

To validate the above adaptive estimation analysis, actual vehicle testing data was obtained and touchpoint estimation results are presented for both linear and nonlinear spring cases. The results of vehicle testing data are shown in FIGS. 2 and 3. In the vehicle testing, actual measurements were made to obtain actual measured data for input voltage of the motor 18, the rotating position of the cam 24 about the second shaft 34, and the velocity of the ball 44. This measurement data is shown in FIGS. 2 and 3 for the two verification cases.

In addition to the measurement data of the voltage, cam position, and ball velocity, the estimation of the clutch touchpoint x_{ct} for both linear clutch spring and nonlinear clutch spring according to the above algorithm are shown, based on the known variables of the system on which the actual verification was performed. Note that for the linear case as shown in FIG. 2, the touchpoint estimation results only valid between 21-23s, which is actually during clutch slip. However, in the nonlinear case, with the consideration of the nonlinear clutch spring stiffness, the touchpoint estimation result is valid between 20-23s, which compared with the linear case, has improved almost 1 second for effective estimation duration with acceptable estimation errors (maximum error is 1.6%). This improvement is important since the total clutch engaging period is only 4 seconds. And note that during the improved duration the clutch operates under overtaken condition. Therefore, by considering the nonlinear spring stiffness, the estimation can be extended to the clutch overtaken and slip conditions.

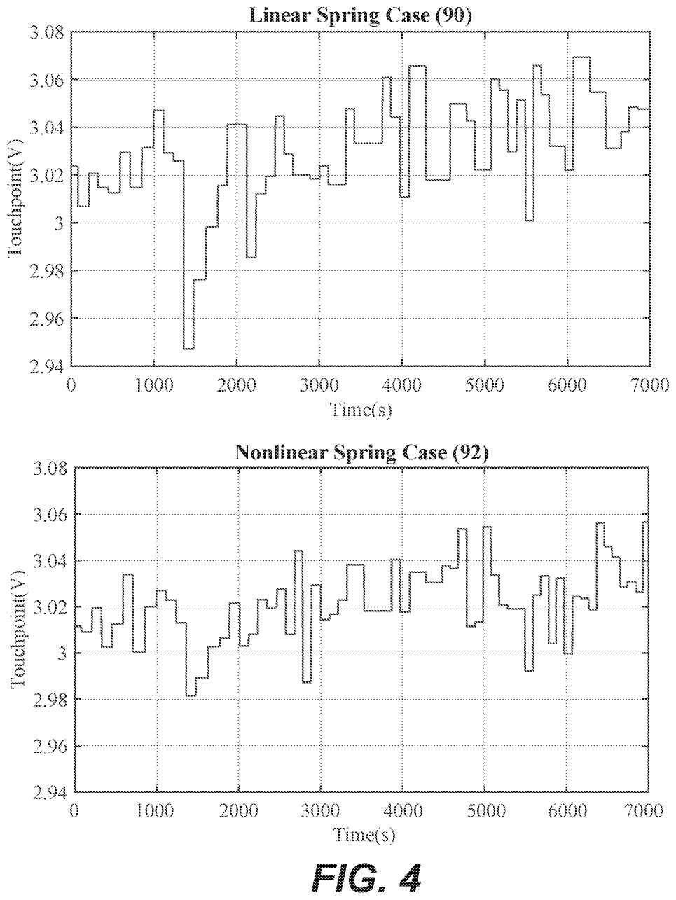

Furthermore, the accuracy and robustness of the algorithms can be evaluated by checking FIG. 4, where the touchpoint estimation results of a linear spring case is presented in graph 90, and the touchpoint estimation results of a nonlinear spring case is presented in graph 92. As shown in FIG. 4, with both linear and nonlinear models, the estimation is accurate since the maximum estimation error is small, around 1.6% for linear case, and 1% for nonlinear case. However, the robustness of both cases appears to be unsatisfactory. In other words, both the linear and nonlinear models produce results with more variation than results from using non-model-based approaches.

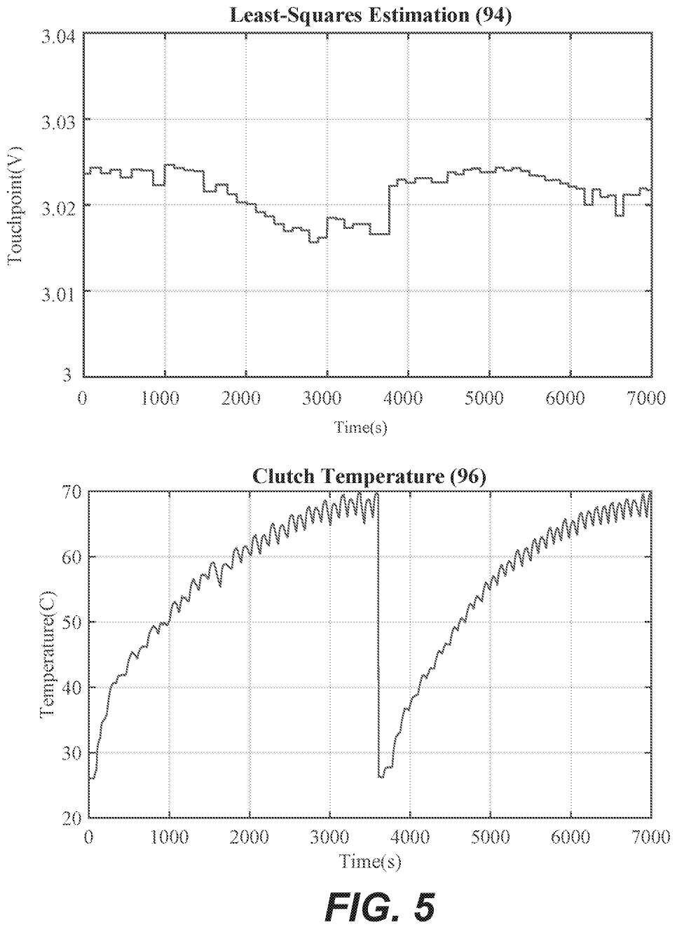

Therefore, the adaptive normalized Least-Squares estimation algorithm is proposed to improve robustness. FIG. 5 shows the estimation results in two graphs 94, 96 having a common time axis. Specifically, graph 94 shows the touchpoint estimation results using the adaptive normalized Least-Squares estimation algorithm, and graph 96 shows clutch temperature over the same timeline as is used in graph 94. The estimation results using the adaptive normalized Least-Squares estimation algorithm have a small mean error (0.8%), which shows that the estimation result is accurate. The estimation results using the adaptive normalized Least-Squares estimation algorithm also have a small standard deviation (0.0074), which shows that the Least-Squares estimation algorithm is more robust than current methods, such as non-model-based approaches which employ table lookups and heavy calibration. In addition, one important feature of the Least-Square estimation algorithm is that the estimated touchpoint displacement x_{ct} decreases as the clutch oil temperature increases, which corresponds to the practical change due to the fact that there is thermal expansion in clutch disks.

A system and method for estimating a surface friction coefficient μ_{c} of a clutch in a vehicle powertrain is also provided. The clutch is configured to selectively couple a driven part to be rotated by a driving part. The subject clutch may be any clutch used in a vehicle powertrain, such as a clutch in a transfer case configured to selectively decouple a motor or engine from driving one or more wheels of a vehicle. The clutch may be any other type of clutch in a vehicle powertrain. For example, the clutch may be used to selectively control transfer of torque in a manual or automatic transmission vehicle. The clutch may be used within a conventional automatic transmission or a dual-clutch transmission. In some embodiments, the clutch may selectively transmit torque between an engine or motor and a transmission. In some embodiments, the clutch may selectively transmit torque between the transmission and one or more wheels of the vehicle. The clutch may have any physical arrangement, including one or more clutch surfaces, which may be operated under either dry conditions or wet conditions, submerged in a liquid.

Based on the estimated clutch surface friction coefficient, a parameterized clutch surface friction coefficient model is also proposed so that the clutch surface friction coefficient can be estimated in real-time. An important aspect to estimate clutch surface friction coefficient is to obtain the torque transmitted through the clutch. The clutch torque estimation is performed under various clutch operation conditions and relies on a vehicle speed estimation, and effective tire radius estimation. A way of estimating the vehicle speed is proposed based on the vehicle body dynamics. The advantage of the proposed speed estimation method is that the algorithm is based on the constraint of total tire force. A novel way of calculating the effective tire radius is described. Particularly, a nominal effective tire radius estimation method is proposed using the tire pressure information, and considering the acceleration effect of the vehicle, the effective tire radius is compensated with a quadratic term of vehicle acceleration. The above proposed way of estimating speed and effective tire radius resulting a good estimation of clutch torque when the clutch works in the overtaken condition. For clutch operation in a slip condition, a further slip speed compensation for the front tires is proposed, and the estimation results closely match the measured clutch torque.

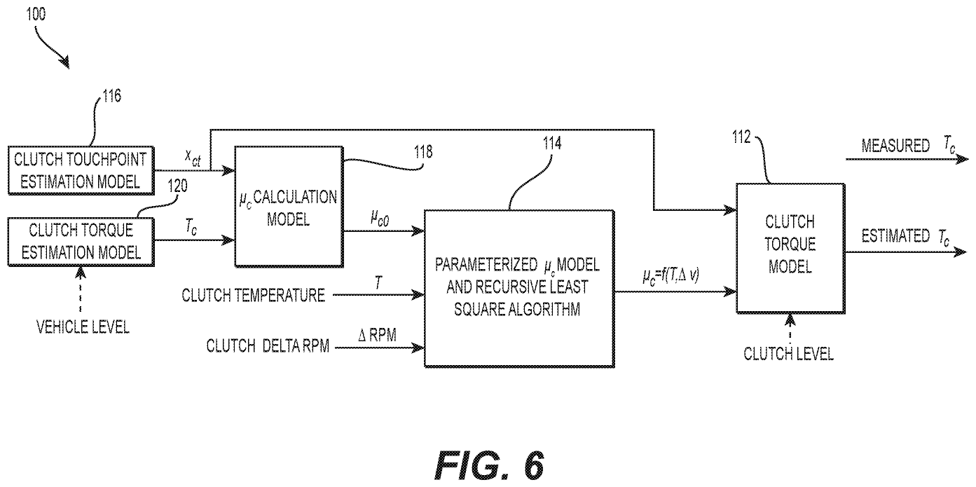

FIG. 6 shows a schematic block diagram of a system 100 for modeling clutch surface friction coefficient μ_{c} and estimating clutch torque T in accordance with the present disclosure. Specifically, the system 100 includes a clutch torque model 112 configured to generate an estimated clutch torque T_{c} as a function of clutch level or actuation position, clutch touchpoint x_{ct}, and the clutch surface friction coefficient μ_{c}. The system 100 also includes a parameterized model 114 configured to determine the clutch surface friction coefficient μ_{c} in real-time and as a function of an initial clutch surface friction coefficient, clutch temperature, and a rotational speed difference between clutch driving and driven plates. The parameterized model 114 may use a recursive least square algorithm to model the clutch surface friction coefficient μ_{c}. The real-time clutch surface friction coefficient μ_{c0} may be calculated by a surface friction coefficient model 118 based upon the clutch touchpoint x_{ct} and an estimated clutch torque T_{c}. The clutch touchpoint x_{ct} is estimated by a clutch touchpoint estimation model 116. The estimated clutch torque T_{c}. may be determined by a clutch torque estimation model 120 under different clutch operating conditions using one or more vehicle operating values, such as speed, acceleration, effective tire radius, etc.

Any or all of the models 112, 114, 116, 118, 120 in the system 100 may be implemented using software, hardware, or a combination of hardware and software. Any or all of the models 112, 114, 116, 118, 120 in the system 100 may be implemented using general-purpose computing devices, such as a microprocessor or microcontroller running a program stored in a non-transient memory. Alternatively or additionally, any or all of the 112, 114, 116, 118, 120 in the system 100 may be implemented using special-purpose computing devices, such as an application-specific integrated circuit (ASIC) and/or a field-programmable gate array (FPGA).

### Clutch Surface Friction Coefficient Estimation

Torque transmitted through a clutch is typically used to estimate the clutch surface friction coefficient. A known relationship between the clutch torque and the friction coefficient is:

T_{c}=μ_{c}n_{c}F_{N}r_{ceff} (27)

where T_{c} is the clutch torque; μ_{c} is the clutch surface friction coefficient; n_{c} is the total effective number of engaging clutch surfaces; F_{N} is the normal force between clutch pack; and r_{ceff} is the effective radius of the clutch.

The clutch normal force F_{N} considering clutch touchpoint distance is usually a piecewise linear function that can be expressed as:

$${F}_{N} = \{ \begin{matrix}0 , & {x}_{p} \leq {x}_{xct} \\ {k}_{c} ( {x}_{p} - {x}_{xct} ) , & {x}_{p} > {x}_{xct}\end{matrix} \qquad ( 28 )$$

where xₚ is the actuated position of the clutch, and x_{ct} is the clutch touchpoint displacement.

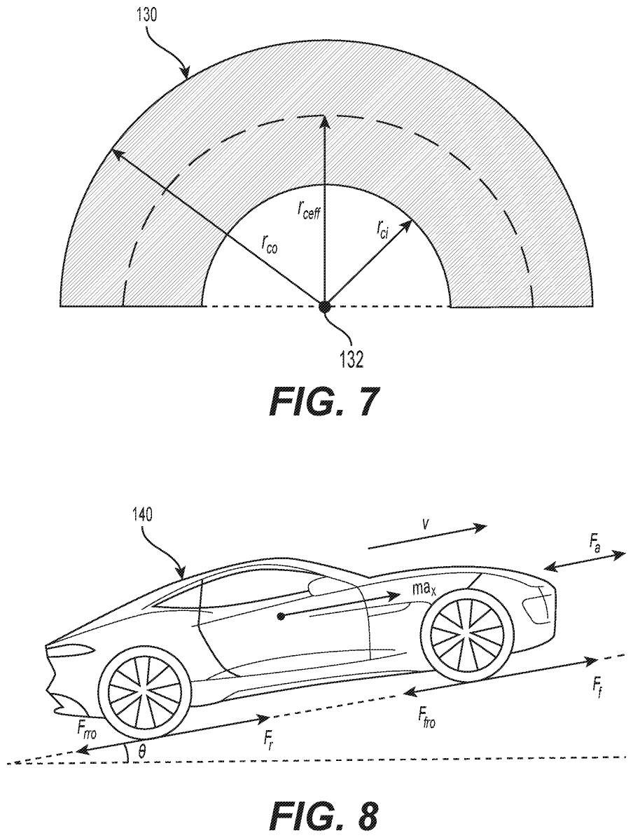

The clutch effective radius r_{ceff} is approximated by equation (29), below, which the parameter relationship is shown with reference to an example clutch 130 in FIG. 7.

$${r}_{ceff} = \frac{{r}_{c o} + {r}_{c i}}{2} \qquad ( 29 )$$

where r_{co} is the clutch outer radius; and r_{ci} is the clutch inner radius.

Therefore, combining equations (27)-(29), the clutch surface friction coefficient μ_{c} can be estimated by equation (30), below:

$${μ}_{c} = \frac{{T}_{c}}{{n}_{c} {F}_{N} {r}_{ceff}} \qquad ( 30 )$$

The first task is to estimate the torque transmitted by the clutch while the vehicle is operating, which will be introduced in the following sections.

### Clutch Torque Estimation

Clutch Torque Estimation under Clutch Overtaken Condition

Consider the vehicle body dynamics, and refer to the free body diagram of a vehicle 140 shown in FIG. 8, the force balance can be expressed as following according to the Newton Second Law:

m\dot{v}=F−Fₐ−(F_{fro}+Fᵣᵣₒ)−mg sin θ (31)

where m is the vehicle mass; v is vehicle longitudinal speed; F is the total longitudinal force respectively; Fₐ is the air drag force; F_{fro} and Fᵣᵣₒ are the front and rear tire rolling resistance respectively; and θ is the road grade angle.

FIG. 8 shows a free body diagram of a vehicle 140 in accordance with the present disclosure. The air drag force Fa acting on the vehicle 140 can be approximated using equation (32), below:

Fₐ=1/2CₐpₐAₐv² (32)

where Cₐ is the air drag coefficient; pₐ is air density; and Aₐ is the vehicle front section area.

The front and rear tire rolling resistance force F_{fro}, and Fᵣᵣₒ, respectively, can be combined to a total tire resistance force, and is usually modeled as a function of vehicle speed, using equation (33), below:

F_{fro}+Fᵣᵣₒ=(aᵣ+bᵣv²)Mg (33)

where aᵣ and bᵣ are empirical calibration coefficients.

Note that the measured acceleration ax usually contains the information of road grade, and can be represented by equation (34), below:

aₓ=\dot{v}+g sin θ (34)

where aₓ is the measured acceleration. Combining equations (31)-(34), the total longitudinal force F_{f}+Fᵣ is given by equation (9), below:

F=maₓ+Fₐ+(F_{fro}+Fᵣᵣₒ) (35)

From this perspective, the longitudinal tire force F is a function of measured vehicle acceleration, which can be measured accurately, and vehicle speed.

The total longitudinal force can also be related with the tire speed and vehicle speed using the relation of equation (36), below:

$$F = {C}_{f} \frac{{r}_{f} {w}_{f} - ν}{{r}_{f} {w}_{f}} + {C}_{r} \frac{{r}_{r} {w}_{r} - ν}{{r}_{r} {w}_{r}} \qquad ( 36 )$$

where C_{f} and Cᵣ are the front and rear longitudinal stiffness, respectively.

Based on equations (35) and (36), equation (37), below, gives an estimate of the vehicle speed based on the vehicle acceleration.

$$v = \frac{( {C}_{f} + {C}_{r} - F ) {r}_{f} {r}_{r} {w}_{f} {w}_{r}}{{C}_{f} {r}_{r} {w}_{r} + {C}_{r} {r}_{f} {w}_{f}} \qquad ( 37 )$$

### Compensated Effective Tire Radius Model

The effective tire radius is calculated using the following equations.

$${r}_{e f} = {r}_{w f} - \frac{{z}_{f}}{3} \qquad ( 38 )$$

where r_{ef} is the front effective tire radius; r_{wf} is the undeformed tire radius; and Z_{f} is the deformation displacement of the front tires. FIG. 9 is a side view diagram of a tire showing the tire radius parameters.

The tire deformation Z_{f} is obtained by the tire normal force using the following equation:

$${z}_{f} = \frac{{F}_{z f}}{{k}_{f t}} \qquad ( 39 )$$

where F_{zf} represents front tire normal force; and k_{ft} represents front tire vertical stiffness.

Tire normal force is obtained by Newton's Law using equation (14), below:

$${F}_{z f} = \frac{{L}_{r}}{{L}_{f} + {L}_{f}} mg \qquad ( 40 )$$

where L_{f} and Lᵣ are the distance between front axle to center of gravity and rear axle to center of gravity.

Tire vertical stiffness is related with tire inflation pressure and tire parameters by equation (41), below:

$${k}_{ft} = {a}_{f} {p}_{ft} \sqrt{( - 0.004 AR + 1.03 ) ( \frac{{S}_{N} A R}{50} + {D}_{R} ) {S}_{N}} + b f \qquad ( 41 )$$

where a_{f} and b_{f} are coefficients that varies for different tires and need to be calibrated; p_{ft} represents front tire inflation pressure; AR is the aspect ratio of tires; S_{N} is the section width of tires; and D_{R} is the tire rim diameter.

The compensated effective tire radius takes the form of equation (42), below:

$${r}_{efc} = \{ \begin{matrix}{r}_{ef} - {ba}_{x}^{2} \\ {r}_{ef}\end{matrix} \begin{matrix}accelerating \\ coasting down\end{matrix} \qquad ( 42 )$$

### Front Tire Dynamics

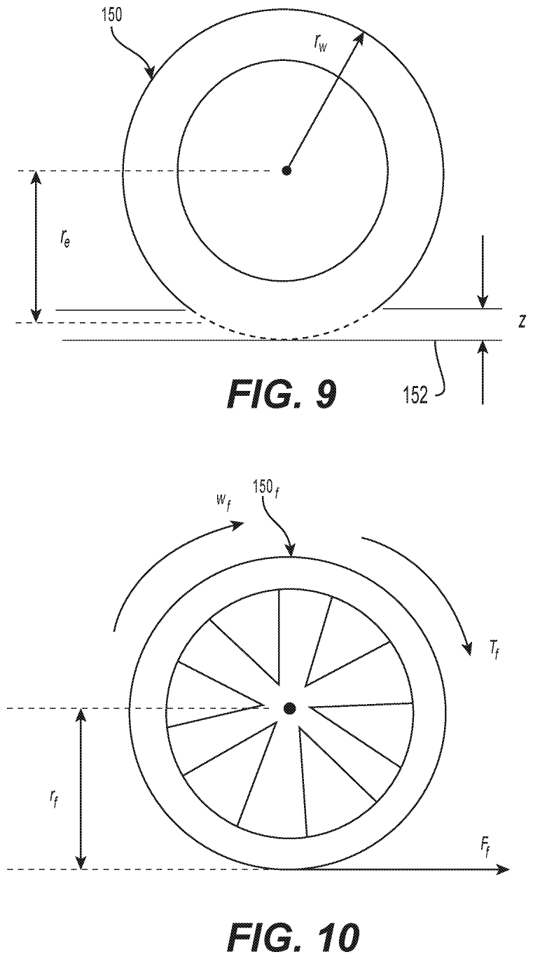

FIG. 10 shows a free body diagram of a front tire 150f. In the free body diagram of the tire, consider the Newton's Law, the following equation can be obtained as equation (43):

$${T}_{f} {i}_{fd} = {J}_{f} {\dot{w}}_{f} + {F}_{f} {r}_{f} \qquad ( 43 )$$

$${F}_{f} = {C}_{f} \frac{{r}_{f} {w}_{f} - v}{{r}_{f} {w}_{f}}$$

where J_{f} is the front wheel inertia; w_{f} is the front wheel speed; T_{f} is the front propeller shaft torque; i_{fd} is the front differential ratio; F_{f} is the front wheel longitudinal force; and r_{f} is the tire effective radius.

If ignoring the mechanical efficiency loss from the clutch to the front propeller shaft, the transmitted clutch torque T_{c} equals to the front propeller shaft torque T_{f}, i.e., T_{c}=T_{f}.

### Torque Estimation Results

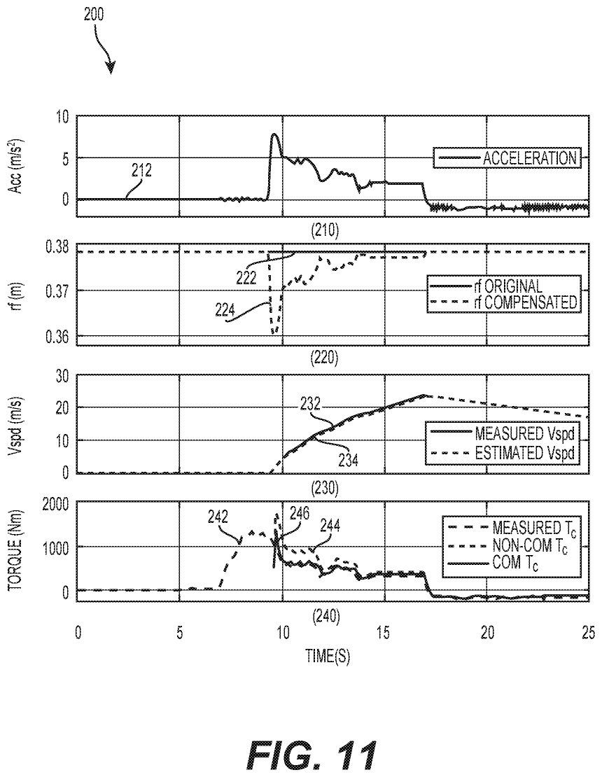

This section shows validation of the proposed method for estimating torque. Note that we can concentrate on the acceleration and coasting down duration data. FIG. 11 shows a graph 200 with plots 210, 220, 230, 240 of acceleration, tire radius, vehicle speed, and clutch torque, respectively, over a common time scale of 0-25s. Specifically, graph 200 shows estimation results under a clutch overtaken condition. First plot 210 includes a line 212 showing vehicle longitudinal acceleration in meters per second-squared (m/s²). Second plot 220 includes a first line 222 showing original or baseline front tire radius r_{f} of a front tire 150f, and a second line 222 showing compensated front tire radius r_{f}, or the effective front tire radius r_{efc} as calculated using the effective tire radius model of the present disclosure, with values in meters (m). In other words, the compensated front tire radius r_{f} plotted by line 222 shows the tire radius is changing according to the vehicle longitudinal acceleration.

Third plot 230 includes a first line 232 showing a measured vehicle speed V_{spd}, and a second line 232 showing estimated vehicle speed V_{spd}, as calculated using the effective tire radius r_{efc} of the present disclosure with values in meters per second (m/s). The estimated vehicle speed is compared to the measured vehicle speed, which is calculated based on the measured wheel rotating speed. As shown in the third plot 230 the estimated speed V_{spd} is very close to the measured speed V_{spd}. Fourth plot 240 shows different values of clutch torque T_{c} in Newton-meters (Nm). The fourth plot 240 includes a first line 242 showing measured clutch torque T_{c}, and a second line 244 showing non-compensated clutch torque T_{c} and a third line 246 showing compensated clutch torque T_{c} calculated in accordance with the present disclosure. The measured clutch torque T_{c} may be determined, for example, using a dynamometer. The measured clutch torque T_{c} may not be available to an onboard controller in the vehicle under normal operation. The compensated clutch torque T_{c} closely tracks the measured clutch torque T_{c}, whereas the non-compensated clutch torque T_{c} deviates significantly from the measured clutch torque T_{c}.

The estimated front torque is shown in the fourth plot 240 of FIG. 11, where it can be seen that during both acceleration and coasting down, with effective tire radius compensation, the estimated result matches perfectly with the actual measured torque. Note that we can ignore the duration other than acceleration and coast down.

Clutch Torque Estimation Model under Clutch Slip Condition

### Modified Model for Vehicle Speed Estimation

Under clutch slip condition, the rotational speed difference between clutch driving and driven parts is defined as Δrpm, and is calculated by equation (44), below:

$$Δ rpm = \frac{{w}_{r}}{{i}_{r d}} - \frac{{w}_{f}}{{i}_{fd}} \qquad ( 44 )$$

where w_{f} and wᵣ are average front and rear tire rotational speed, respectively; i_{fd} and i_{rd} are front and rear differential ratio, respectively.

Therefore, the slip speed in the front tires transmitted from clutch slip can be calculated by equation (45), below:

Δv=1/2i_{fd}w_{f}Δrpm (45)

The actual front tires linear speed with slip speed compensation under clutch slip condition is defined by equation (46), below:

v_{fc}=r_{efc}w_{f}+Δv (46)

where v_{fc} is the compensated front tires speed. The front tire force in equation (36) is then replaced by:

$${F}_{fc} = {C}_{f} \frac{{ν}_{fc} - ν}{{ν}_{fc}} \qquad ( 47 )$$

where F_{fc} is the compensated front tire force.

The speed estimation formula (37) is converted to the following form under clutch slip condition.

$${v}_{c} = \frac{( {C}_{f} + {C}_{r} - ( {F}_{f} + {F}_{r} ) ) {ν}_{fc} {r}_{r} {w}_{r}}{{C}_{f} {r}_{r} {w}_{r} + {C}_{r} {ν}_{fc}} \qquad ( 48 )$$

where v_{c} is the compensated vehicle speed.

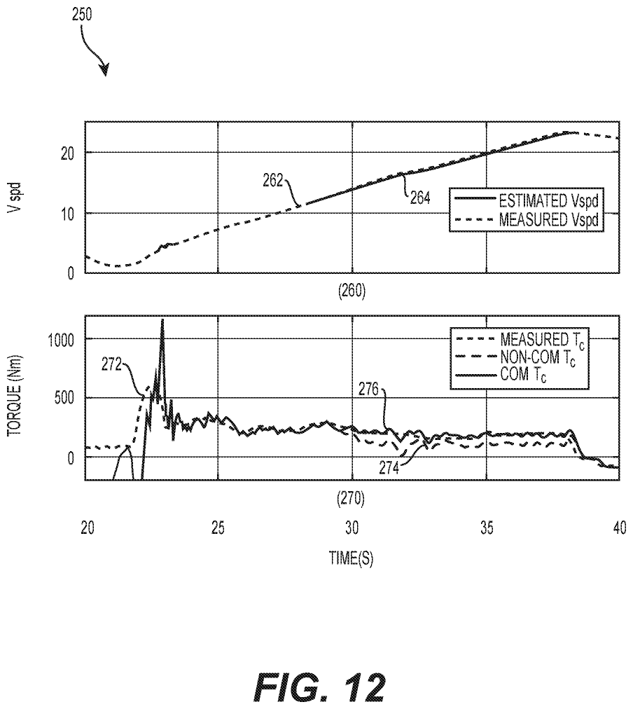

FIG. 12 shows a graph 250 with plots 260, 270 of vehicle speed and clutch torque over a common time scale. Specifically, FIG. 7 shows the clutch torque estimation under clutch slip condition. Plot 260 includes a first line 262 of estimated vehicle speed V_{spd} and a second line 264 of measured vehicle speed V_{spd}, with values in meters per second (m/s). The estimated vehicle speed V_{spd} is calculated using a method of the present disclosure, with speed compensation under the clutch slipping condition. The estimated vehicle speed is compared to the measured vehicle speed, which is calculated based on the measured wheel rotating speed. As shown in the plot 260 the estimated vehicle speed V_{spd} with slip speed compensation is still very close to the measured speed. Plot 270 shows different values of clutch torque T_{c} in Newton-meters (Nm). Plot 270 includes a first line 272 showing measured clutch torque T_{c}, and a second line 274 showing non-compensated clutch torque T_{c} and a third line 276 showing compensated clutch torque T_{c} calculated in accordance with the present disclosure. The compensated clutch torque T_{c} shows improved estimation performance to match the measured clutch torque T_{c} compared with the clutch torque T_{c} without compensation.

### Parameterized Clutch Surface Friction Coefficient Model

### Parameterized Model Development

Once the clutch surface friction coefficient is obtained through equation (30), to get the clutch surface friction coefficient in real time, a parameterized clutch surface friction coefficient model can be established relating it with the clutch surface friction material, clutch operating temperature and the clutch slip speed. The mathematical description can be expressed as:

μ_{c}=μ₀+aT₀+bΔrpm (49)

where μ₀ is the initial clutch surface friction coefficient determined by the clutch material; Tₒ is the clutch operating temperature; [symbol] rpm is the clutch slip speed between the driving part and driven part; and the coefficients a and b are to be determined.

The model can be further arranged to the following linear parametric form:

y=θ*φ (50)

where y=μc is the model output; θ*=[μ₀ a b] is the unknown coefficients vector to be estimated; and

$$φ = [ \begin{matrix}1 \\ {T}_{0} \\ Δ rpm\end{matrix} ]$$

is the known regression vector.

Letting θ be an estimate of θ*, the following output error parametric form in discrete time with sampling time T can be obtained:

ε(k)=\tilde{θ}(k)ϕ(k) (51)

where ε(k)=y(k)−θ(k)ϕ(k) is the output error; and \tilde{θ}(k)=θ(k)−θ* is the parameter error.

An adaptive estimation algorithm based on the normalized gradient method can be used to estimate θ.

$$θ ( k + 1 ) = \{ \begin{matrix}θ ( k ) - \frac{Γ ϕ ( k ) ε ( k )}{{m}^{2} ( k )} & \underline{θ} < θ ( k ) < \overline{θ} \\ θ ( k ) & otherwise\end{matrix} \qquad ( 52 )$$

where m²(k)=τ+ϕ^{T}(k)ϕ(k) is designed to guarantee the boundedness of the estimation algorithm, and τ>0 is a designing parameter that determines the estimation convergence rate. F is another design parameter satisfying 0<Γ<2I to guarantee the convergence of the output error, where I is an identity matrix with appropriate dimension; θ and θ̅ are calibrated lower and upper bound for θ, respectively.

### Enabling Conditions Specification

Note that the parameterized model will only update the friction coefficient model when the vehicle is operating under certain conditions. These conditions are chosen based on the model accuracy. This will not impact the overall estimation due to the fact that the friction coefficient changes slowly with time. This implies the friction coefficient surface will only be updated when modeling is accurate and represents the actual physics of the system. The following conditions are specified to ensure the accuracy of the updated adaptive friction surface.

TABLE 1

| | Parameter | Conditions | | Note |
|---|---|---|---|---|
| Touchpoint | Vehicle Speed(v) | v > | v₀ | Vehicle is |
| estimation | | | | moving |
| | Vehicle | a > | a₀ | Vehicle is |
| | acceleration(a) | | | accelerating |
| | Input Voltage(u) | u ∈ | [u₀, 0] | Clutch is |
| | Ball Velocity(v_{b}) | v_{b} ∈ | [v_{b0}, 0] | engaging |
| | Ball displacement(xₚ) | xₚ > | x_{c0} | |
| | Motor Brake(Bₘ) | Bₘ = | 0 | No external force |
| | | | | on the motor |
| | Vehicle Brake(Bᵥ) | Bᵥ = | 0 | No external force |
| | | | | on the motor |
| Clutch | Vehicle | Cᵥ < | \|c₀\| | Vehicle speed |
| torque | Cornering(Cᵥ) | | | estimation is |
| estimation | | | | accurate |
| | [symbol] rpm | [symbol] rpm > | Δ₀ | The clutch is |
| | | | | slipping |

### Conclusion of Clutch Surface Friction Coefficient Estimation Model

In conclusion, first, the clutch surface friction coefficient estimation model is established; second, the clutch torque is estimated under various clutch operation conditions and the estimation shows the validity of the proposed estimation scheme; finally, a parameterized model of clutch surface friction coefficient for real-time estimation using the adaptive estimation algorithm is proposed.

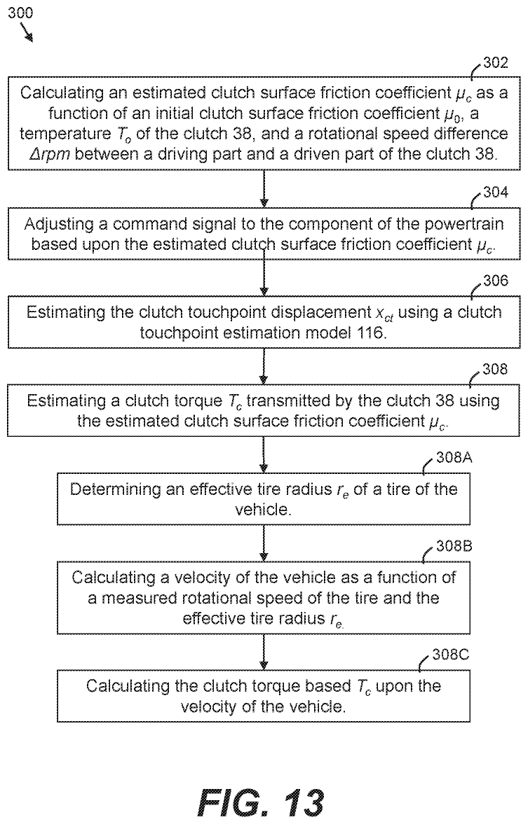

In accordance with an aspect of the disclosure and as shown in the flow chart on FIG. 13, a first method 300 of controlling a component of a powertrain of a vehicle is provided. The provided first method 300 may provide for smoother and/or more efficient operation of the vehicle powertrain. For example, the provided first method 300 may allow a clutch to be operated with an actuation force that causes the clutch to produce a desired output torque that is more precise than is possible with conventional methods. The provided first method 300 may allow a smoother operation of the clutch 38 and/or a smoother operation of the vehicle powertrain as a whole, when compared with conventional methods.

The first method 300 includes a first step 302 of calculating an estimated clutch surface friction coefficient μ_{c} as a function of an initial clutch surface friction coefficient μ₀, a temperature Tₒ of the clutch 38, and a rotational speed difference [symbol] rpm between a driving part and a driven part of the clutch 38.

In some embodiments, a parameterized model is used to calculate the estimated clutch surface friction coefficient μ_{c}. In some embodiments, the first method 300 includes estimating the clutch surface friction coefficient μ_{c} in real time during operation of the vehicle. In some embodiments, the estimated clutch surface friction coefficient μ_{c} is calculated only when a given set of vehicle operating parameters are within corresponding predetermined conditions. For example, the estimated clutch surface friction coefficient μ_{c} may be calculated only when the clutch is to be engaged or disengaged, or when an input to the clutch is driven above a predetermined speed and/or above a predetermined torque.

The estimated clutch surface friction coefficient μ_{c} may be calculated in the first step 302 according to the equation μ_{c}=μ₀+aTₒ+bΔrpm, where μ_{c} is the estimated clutch surface friction coefficient, go is the initial clutch surface friction coefficient determined by the clutch material; Tₒ is the clutch operating temperature, Δrpm is the rotational speed between the driving part and driven part, and a and b are coefficients to be determined. In some embodiments, calculating the estimated clutch surface friction coefficient μ_{c} further comprises determining values of the coefficients a and b using an adaptive estimation model.

The first method 300 proceeds with a second step 304 of adjusting a command signal to the component of the powertrain based upon the estimated clutch surface friction coefficient μ_{c}. The command signal may be generated by a controller, such as a powertrain control module (PCM), to control operation of the component of the powertrain. The component of the powertrain may be a clutch actuator configured to actuate the clutch. For example, adjusting the operation of the component of the powertrain may include adjusting a command signal, such as a position command or a torque command, supplied to the clutch actuator. The clutch actuator may include the electric motor 18, although other actuators may be used, such as a hydraulic cylinder. Alternatively or additionally, the component of the powertrain may be a prime mover, such as an electric motor or an internal combustion engine configured to supply an input torque to the driving part of the clutch. For example, adjusting the command signal to the component of the powertrain may include adjusting a torque command, an applied voltage, or a throttle position of the prime mover. This second step 304 may include adjusting other components of the powertrain, such as a gear selection or a gear ratio setting in a transmission or other gearbox.

In some embodiments, the first method 300 further comprises estimating the clutch touchpoint displacement x_{ct} using a clutch touchpoint estimation model 116 at step 306.

In some embodiments, the first method 300 further comprises estimating a clutch torque T_{c} transmitted by the clutch 38 using the estimated clutch surface friction coefficient μ_{c} at step 308. For example, the clutch torque T_{c} transmitted by the clutch 38 may be estimated with the clutch in an overtaken condition. Alternatively or additionally, the clutch torque T_{c} transmitted by the clutch 38 may be estimated with the clutch 38 in a slip condition. The estimated clutch torque T_{c} transmitted by the clutch 38 may be used for adjusting the command signal to the component of the powertrain, similarly to how the command signal is adjusted based upon the estimated clutch surface friction coefficient μ_{c} at step 304.

In some embodiments, step 308 of estimating the clutch torque T_{c} transmitted by the clutch 38 further comprises the first sub-step 308A of determining an effective tire radius re of a tire of the vehicle. The effective tire radius may include a tire deformation as a function of a normal force acting upon the tire and as a function of a vertical stiffness of the tire. For example, a compensated effective tire radius may be calculated in accordance with

$${r}_{e} = {r}_{w} - \frac{{z}_{f}}{3}$$

where rₑ is the effective tire radius; r_{w} is the undeformed tire radius; and z is the deformation displacement of the tire.

Step 308 of estimating the clutch torque T_{c} transmitted by the clutch 38 may further include the second sub-step 308B of calculating a velocity of the vehicle as a function of a measured rotational speed of the tire and the effective tire radius rₑ. Step 308 of estimating the clutch torque T_{c} transmitted by the clutch 38 may further include the third sub-step 308C of calculating the clutch torque based T_{c} upon the velocity of the vehicle.

Step 308 of estimating the clutch torque T_{c} transmitted by the clutch 38 may further include calculating an estimated clutch torque T_{c} as a function of the estimated clutch surface friction coefficient μ_{c} and a normal force F_{N} between the engaging clutch surfaces in the clutch 38; and calculating the normal force F_{N} between the engaging clutch surfaces in the clutch 38 as a function of clutch displacement position and a clutch nominal touchpoint displacement. For example, the estimated clutch torque T_{c} may be calculated in accordance with T_{c}=,μ_{c}n_{c}F_{N}r_{ceff} where T_{c} is the estimated clutch torque, μ_{c} is the estimated clutch surface friction coefficient, n_{c} is a total effective number of engaging clutch surfaces in the clutch 38, F_{N} is the normal force between the engaging clutch surfaces in the clutch 38, and r_{ceff} is an effective radius of the engaging clutch surfaces in the clutch 38.

In some embodiments, the clutch effective radius r_{ceff} may be approximated as

$${r}_{ceff} = \frac{{r}_{c o} + {r}_{c i}}{2} ,$$

where r_{co} is the clutch outer radius; and r_{ci} is the clutch inner radius.

In some embodiments, the normal force between the engaging clutch surfaces in the clutch may be determined as

$${F}_{N} = \{ \begin{matrix}0 , & {x}_{p} \leq {x}_{x c t} \\ {k}_{c} ( {x}_{p} - {x}_{x c t} ) , & {x}_{p} > {x}_{x c t}\end{matrix}$$

where F_{N} is the normal force between the engaging clutch surfaces, xₚ is an actuated position of the clutch; k_{c} is a clutch spring axial stiffness; and x_{ct} is the clutch touchpoint displacement.

In some embodiments, the parameterized model uses an adaptive estimation algorithm to estimate a vector of unknown coefficients relating the clutch operating temperature and the rotational speed difference between clutch driving and driven parts to the estimated clutch surface friction coefficient. In some embodiments, the adaptive estimation algorithm may include a recursive least square algorithm, although other algorithms may be used.

In some embodiments, the adaptive estimation algorithm includes calculating

$$θ ( k + 1 ) = \{ \begin{matrix}θ ( k ) - \frac{Γ ϕ ( k ) ε ( k )}{{m}^{2} ( k )} & \underline{θ} < θ ( k ) < \overline{θ} \\ θ ( k ) & otherwise\end{matrix}$$

where θ is the vector of unknown coefficients relating the clutch operating temperature and the rotational speed difference between clutch driving and driven parts to the estimated clutch surface friction coefficient, m²(k)=τ+ϕ^{T} (k)ϕ(k) is designed to guarantee the boundedness of the estimation algorithm, and τ>0 is a designing parameter that determines the estimation convergence rate. Γ is another design parameter satisfying 0<Γ<2I to guarantee the convergence of the output error, where I is an identity matrix with appropriate dimension; θ and θ̅ are calibrated lower and upper bound for θ, respectively.

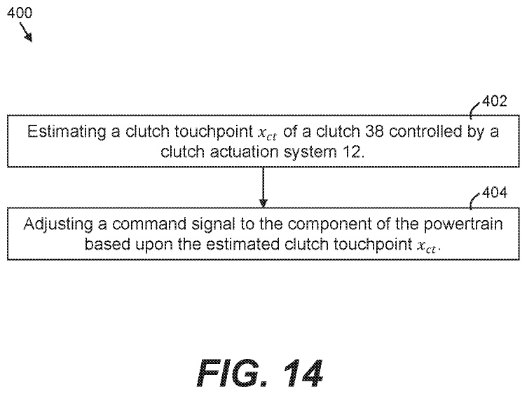

In accordance with an aspect of the disclosure, and as shown in the flow chart of FIG. 14, a second method 400 of controlling a component of a powertrain of a vehicle is provided. The provided second method 400 may provide for smoother and/or more efficient operation of the vehicle powertrain. For example, the second method 400 may allow a clutch 38 to be operated with an actuation force that causes the clutch to produce a desired output torque that is more precise than is possible with conventional methods. The second method 400 may allow a smoother operation of the clutch 38 and/or a smoother operation of the vehicle powertrain as a whole, when compared with conventional methods.

The second method 400 includes a first step 402 of estimating a clutch touchpoint x_{ct} of a clutch 38 controlled by a clutch actuation system 12. The clutch actuation system 12 includes an electric motor 18 having a first shaft 32, a reduction gear 20 coupled to the first shaft 32, a second shaft 34 coupled to the reduction gear 20, and a cam system 22 coupled to the first shaft 32. The cam system 22 includes a ball 44 configured to translate in an axial direction and to impart a clutch engagement force on a clutch pack 38, which may also be called the clutch 38. Rotation of the second shaft 34 causes axial translation of the ball 44. The clutch touchpoint x_{ct} corresponds to the axial translation of the ball 44 where the clutch pack 38 first transmits torque.

Estimating the clutch touchpoint x_{ct} of the clutch 38 includes determining the clutch touchpoint x_{ct} as a function of: a conversion rate correlating the axial translation of the ball 44 to a rotation angle of a plate 28 defining a ramp 48 and configured to rotate about an axis to cause the axial translation of the ball 44, a total friction force on the ball 44, an angle between the ramp 48 and a plane of the plate 28 perpendicular to the axis, an axial stiffness of a clutch spring acting upon the clutch 38, a reduction gear ratio of the reduction gear 20, an equivalent gear ratio between the second shaft 34 and the plate 28, a mechanical efficiency between the first shaft 32 and the second shaft 34, a mechanical efficiency between the second shaft 34 and the plate 28, a mechanical efficiency between the plate 28 and the ball 44, and an orbital radius of the ball 44.

More specifically, the clutch touchpoint x_{ct} may include estimating and converging an unknown term d in order to determine the clutch touchpoint x_{ct} based on the equation

$${x}_{c t} = {p}_{0} {k}_{p} {a}_{c a m} + {p}_{0} {a}_{p} + \frac{{F}_{f}}{tan β {k}_{c}} - \frac{{i}_{r} {i}_{s} {η}_{r} {η}_{s} {η}_{p}}{{k}_{c} tan β {r}_{b}} d ,$$

where kₚ, a_{cam}, and aₚ are constants, p₀ represents the conversion rate correlating the axial translation of the ball 44 to the rotation angle of the plate 28, F_{f} represents the total friction force on the ball 44, β represents the angle between the ramp 48 and the plane of the plate 28 perpendicular to the axis, k_{c} represents the axial stiffness of the clutch spring acting upon the clutch, iᵣ represents the reduction gear ratio of the reduction gear 20, iₛ represents the equivalent gear ratio between the second shaft 34 and the plate 28, ηᵣ represents the mechanical efficiency between the first shaft and the second shaft, ηₛ represents the mechanical efficiency between the second shaft 34 and the plate 28, ηₚ represents the mechanical efficiency between the plate 28 and the ball 44, r_{b} represents the orbital radius of the ball 44, and d represents the unknown term.

In some embodiments, the second method 400 includes estimating the clutch touchpoint x_{ct} in real time during operation of the vehicle. In some embodiments, estimating the clutch touchpoint x_{ct} of the clutch 38 includes accounting for a non-linear stiffness of the clutch spring. In some embodiments, estimating the clutch touchpoint x_{ct} of the clutch 38 includes performing a recursive least square algorithm.

In some embodiments, the second method 400 includes estimating the clutch touchpoint x_{ct} by estimating and converging an unknown term d and calculating the clutch touchpoint x_{ct} according to the equation

$${x}_{c t} = {p}_{0} {k}_{p} {a}_{c a m} + {p}_{0} {a}_{p} + \frac{{F}_{f}}{tan β {k}_{c}} - \frac{{i}_{r} {i}_{s} {η}_{r} {η}_{s} {η}_{p}}{{k}_{c} tan β {r}_{b}} d .$$

In some embodiments, the second method 400 also includes recording measurable variables of the clutch actuation system 12, and wherein, when the clutch pack 38 is engaged, load torque on the first shaft 32 is modeled according to equation:

$${T}_{l 1} = K {θ}_{1} + d where K = \frac{{k}_{c} tan β {r}_{b} {k}_{c a m} {p}_{0} {k}_{p}}{{i}_{r}^{2} {i}_{s} {η}_{r} {η}_{s} {η}_{p}} and$$

$$d = \frac{{k}_{c} tan β {r}_{b}}{{i}_{r} {i}_{s} {η}_{r} {η}_{s} {η}_{p}} ( {p}_{0} {k}_{p} {b}_{c a m} + {p}_{0} {a}_{p} - {x}_{c t} ) .$$

The second method 400 proceeds with a second step 404 of adjusting a command signal to the component of the powertrain based upon the estimated clutch touchpoint x_{ct}. The command signal may be generated by a controller, such as a powertrain control module (PCM), to control operation of the component of the powertrain. The component of the powertrain may be a clutch actuator configured to actuate the clutch. For example, adjusting the command signal to the component of the powertrain may include adjusting a position command or a torque command supplied to the clutch actuator. The clutch actuator may include the electric motor 18, although other actuators may be used, such as a hydraulic cylinder. Alternatively or additionally, the component of the powertrain may be a prime mover, such as an electric motor or an internal combustion engine configured to supply an input torque to the driving part of the clutch. For example, adjusting the command signal to the component of the powertrain may include adjusting a torque command, an applied voltage, or a throttle position of the prime mover. This second step 404 may include adjusting other components of the powertrain, such as a gear selection or a gear ratio setting in a transmission or other gearbox.

The foregoing description is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Obviously, many modifications and variations of the present invention are possible in light of the above teachings and may be practiced otherwise than as specifically described while within the scope of the appended claims. These antecedent recitations should be interpreted to cover any combination in which the inventive novelty exercises its utility.

1. A method of controlling a component of a powertrain of a vehicle, comprising:
calculating an estimated clutch surface friction coefficient as a function of an initial clutch surface friction coefficient, a temperature of the clutch, and a rotational speed difference between a driving part and a driven part of the clutch; and
adjusting a command signal to the component of the powertrain based upon the estimated clutch surface friction coefficient, where the component of the powertrain is one of a clutch actuator configured to actuate the clutch or a prime mover configured to supply an input torque to the driving part of the clutch.

2. The method of claim 1, wherein calculating an estimated clutch surface friction coefficient is performed by a parameterized model in real time during operation of the vehicle.

3. The method of claim 1, wherein the component of the powertrain is the clutch actuator configured to actuate the clutch.

4. The method of claim 1, wherein the step of calculating the estimated clutch surface friction coefficient is performed according to an equation μ_{c}=μ₀+aTₒ+b [symbol] rpm, where μ_{c} is the estimated clutch surface friction coefficient, μ₀ is the initial clutch surface friction coefficient and is determined by a clutch material; Tₒ is the clutch operating temperature, [symbol] rpm is the rotational speed between the driving part and driven part, and a and b are coefficients to be determined.

5. The method of claim 4, wherein the step of calculating the estimated clutch surface friction coefficient further comprises determining values of the coefficients a and b using an adaptive estimation model.

6. The method of claim 1, further comprising: estimating a clutch touchpoint displacement using a clutch touchpoint estimation model; and
adjusting the command signal to the component of the powertrain based upon the estimated clutch touchpoint displacement.

7. The method of claim 1, further comprising estimating a clutch torque transmitted by the clutch using the estimated clutch surface friction coefficient.

8. The method of claim 7, wherein estimating the clutch torque transmitted by the clutch further comprises:
determining an effective tire radius of a tire of the vehicle, the effective tire radius including a tire deformation as a function of a normal force acting upon the tire and as a function of a vertical stiffness of the tire;
calculating a velocity of the vehicle as a function of a measured rotational speed of the tire and the effective tire radius; and
calculating the clutch torque based upon the velocity of the vehicle.

9. The method of claim 7, wherein estimating the clutch torque transmitted by the clutch further comprises:
calculating an estimated clutch torque as a function of the estimated clutch surface friction coefficient and a normal force between two or more engaging clutch surfaces in the clutch; and
calculating the normal force between the two or more engaging clutch surfaces in the clutch as a function of clutch displacement position and a clutch nominal touchpoint displacement.

10. The method of claim 9, wherein calculating the estimated clutch torque as a function of the estimated clutch surface friction coefficient and the normal force between the two or more engaging clutch surfaces in the clutch is performed in accordance with T_{c}=μ_{c}n_{c}F_{N}r_{ceff}, where T_{c} is the estimated clutch torque, μ_{c} is the estimated clutch surface friction coefficient, n_{c} is a total effective number of engaging clutch surfaces in the clutch, F_{N} is the normal force between the engaging clutch surfaces in the clutch, and r_{ceff} is an effective radius of the engaging clutch surfaces in the clutch.

11. A method of controlling a component of a powertrain of a vehicle, comprising:
estimating a clutch touchpoint x_{ct} of a clutch controlled by a clutch actuation system including an electric motor having a first shaft, a reduction gear coupled to the first shaft, a second shaft coupled to the reduction gear, and a cam system coupled to the first shaft; and
adjusting a command signal to the component of the powertrain based upon the estimated clutch touchpoint x_{ct} of the clutch, where the component of the powertrain is one of the clutch actuation system or a prime mover configured to supply an input torque to a driving part of the clutch;
wherein the cam system includes a ball configured to translate in an axial direction and to impart a clutch engagement force on a clutch pack, wherein rotation of the second shaft causes an axial translation of the ball;
wherein the clutch touchpoint x_{ct} corresponds to the axial translation of the ball where the clutch first transmits torque; and
wherein estimating the clutch touchpoint x_{ct} of the clutch includes determining the clutch touchpoint x_{ct} as a function of: a conversion rate correlating the axial translation of the ball to a rotation angle of a plate defining a ramp and configured to rotate about an axis to cause the axial translation of the ball, a total friction force on the ball, an angle between the ramp and a plane of the plate perpendicular to the axis, an axial stiffness of a clutch spring acting upon the clutch, a reduction gear ratio of the reduction gear, an equivalent gear ratio between the second shaft and the plate, a mechanical efficiency between the first shaft and the second shaft, a mechanical efficiency between the second shaft and the plate, a mechanical efficiency between the plate and the ball, and an orbital radius of the ball.

12. The method of claim 11, wherein the clutch touchpoint x_{ct} is determined based on the equation
$${x}_{c t} = {p}_{0} {k}_{p} {a}_{c a m} + {p}_{0} {a}_{p} + \frac{{F}_{f}}{tan β {k}_{c}} - \frac{{i}_{r} {i}_{s} {η}_{r} {η}_{s} {η}_{p}}{{k}_{c} tan β {r}_{b}} d ,$$
where kₚ, a_{cam}, and aₚ are constants, p₀ represents the conversion rate correlating the axial translation of the ball to the rotation angle of the plate, F_{f} represents the total friction force on the ball, β represents the angle between the ramp and the plane of the plate perpendicular to the axis, k_{c} represents the axial stiffness of the clutch spring acting upon the clutch, iᵣ represents the reduction gear ratio of the reduction gear, iₛ represents the equivalent gear ratio between the second shaft and the plate, ηᵣ represents the mechanical efficiency between the first shaft and the second shaft, ηₛ represents the mechanical efficiency between the second shaft and the plate, ηₚ represents the mechanical efficiency between the plate and the ball, r_{b} represents the orbital radius of the ball, and d represents an unknown term; and
wherein calculating the clutch touchpoint x_{ct} includes estimating and converging the unknown term d.

13. The method of claim 11, wherein the clutch touchpoint x_{ct} is estimated in real time during operation of the vehicle.

14. The method of claim 11, wherein estimating the clutch touchpoint x_{ct} of the clutch includes accounting for a non-linear stiffness of the clutch spring.

15. The method of claim 11, wherein estimating the clutch touchpoint x_{ct} of the clutch includes performing a recursive least square algorithm.

16. The method of claim 9, wherein the normal force between the engaging clutch surfaces in the clutch is determined based on the equation
$${F}_{N} = \{ \begin{matrix}0 , & {x}_{p} \leq {x}_{x c 0} + {x}_{0} \\ {k}_{c} ( {x}_{p} - {x}_{x c 0} - {x}_{0} ) , & {x}_{p} > {x}_{x c 0} + {x}_{0}\end{matrix}$$
where F_{N} is the normal force between the engaging clutch surfaces, xₚ is an actuated position of the clutch, k_{c} is a clutch spring axial stiffness, x_{c0} is a clutch nominal touchpoint displacement, and x₀ is a clutch touchpoint variation displacement.

17. The method of claim 2, wherein the parameterized model uses an adaptive estimation algorithm to estimate a vector of unknown coefficients relating the clutch operating temperature and the rotational speed difference between clutch driving and driven parts to the clutch surface friction coefficient.

18. The method of claim 17, wherein the adaptive estimation algorithm includes a recursive least square algorithm.

19. The method of claim 17, wherein the adaptive estimation algorithm includes a normalized gradient method.

20. The method of claim 1, wherein the calculating the estimated clutch surface friction coefficient is performed only when a given set of vehicle operating parameters are within corresponding predetermined conditions.
